(19) United States
(12) Patent Application Publication
(10) Pub. No.: US 2020/0182623 A1
(43) Pub. Date: Jun. 11, 2020

(54) METHOD, SYSTEM AND APPARATUS FOR DYNAMIC TARGET FEATURE MAPPING

(71) Applicant: Zebra Technologies Corporation, Lincolnshire, IL (US)

(72) Inventors: Zichen Huang, Richmond Hill (CA); Harsoveet Singh, Mississauga (CA); Mahyar Vajedi, Mississauga (CA)

(21) Appl. No.: 16/214,764

(22) Filed: Dec. 10, 2018

(51) Int. Cl. G01C 21/20; G05D 1/00; G05D 1/02

(52) U.S. Cl. CPC G01C 21/206; G05D 1/0094; G06Q 10/087; G05D 1/0088; G05D 1/0274

(57) ABSTRACT

A method for dynamic target feature mapping in a mobile automation apparatus includes, at a navigational controller of the apparatus: obtaining mapping trajectory data defining a trajectory traversing a facility to be mapped; controlling a locomotive mechanism of the apparatus to traverse the trajectory; generating a sequence of keyframes and corresponding estimated mobile automation apparatus poses in a facility frame of reference during traversal of the trajectory, using a navigational sensor of the mobile automation apparatus; simultaneously with generating a target-associated one of the keyframes, detecting a target feature using an environmental sensor of the mobile automation apparatus; storing a relative target location of the target feature, defined relative to the estimated pose of the target-associated keyframe; generating a map of the facility based on the sequence of keyframes; and storing a final target location for the target feature, defined in the facility frame of reference.

### BACKGROUND

Environments in which objects are managed, such as retail facilities, may be complex and fluid. For example, a retail facility may include objects such as products for purchase, a distribution environment may include objects such as parcels or pallets, a manufacturing environment may include objects such as components or assemblies, a healthcare environment may include objects such as medications or medical devices.

A mobile apparatus may be employed to perform tasks within the environment, such as capturing data for use in identifying products that are out of stock, incorrectly located, and the like. To perform such tasks, the mobile apparatus may be controlled to travel to one or more previously established target locations represented in a map of the facility. The target locations may be placed manually in the map after the map is generated, e.g. via a simultaneous localization and mapping (SLAM) process. Localization errors during the SLAM process can lead to distortions in the map, however, and manual placement of target locations can introduce further errors in the mapped target locations relative to the corresponding true locations in the facility.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a mobile automation system.

FIG. 2A depicts a mobile automation apparatus in the system of FIG. 1.

FIG. 2B is a block diagram of certain internal hardware components of the mobile automation apparatus in the system of FIG. 1.

FIG. 2C is a block diagram of certain internal components of the mobile automation apparatus of FIG. 1.

FIG. 3 is a flowchart of a method for dynamic loop closure in mapping trajectories for the mobile automation apparatus of FIG. 1.

FIG. 4A is a diagram illustrating an overhead view of a mapping trajectory within a facility.

FIG. 4B is a diagram illustrating an interface presented on the client device of FIG. 1.

FIG. 5A is a diagram illustrating traversal of a portion of the trajectory of FIG. 4 by the mobile automation apparatus of FIG. 1.

FIG. 5B is a diagram illustrating keyframes generated by the mobile automation apparatus of FIG. 1 during the traversal shown in FIG. 5A.

FIG. 6A is a diagram illustrating further traversal of the trajectory of FIG. 4 by the mobile automation apparatus of FIG. 1.

FIG. 6B is a diagram illustrating results of a pose graph optimization performed by the mobile automation apparatus of FIG. 1.

FIG. 7 is a diagram illustrating the keyframes of FIG. 5A following the pose graph optimization.

FIG. 8A is a diagram illustrating determination of a final target location from the keyframes shown in FIG. 7.

FIG. 8B is a diagram illustrating a map generated through performance of the method of FIG. 3, using the final target location of FIG. 8A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method for dynamic target feature mapping in a mobile automation apparatus, the method comprising: at a navigational controller of the mobile automation apparatus, obtaining mapping trajectory data defining a trajectory traversing a facility to be mapped; at the navigational controller, controlling a locomotive mechanism of the mobile automation apparatus to traverse the trajectory; at the navigational controller, generating a sequence of keyframes and corresponding estimated mobile automation apparatus poses in a facility frame of reference during traversal of the trajectory, using a navigational sensor of the mobile automation apparatus; at the navigational controller, simultaneously with generating a target-associated one of the keyframes, detecting a target feature using an environmental sensor of the mobile automation apparatus; storing a relative target location of the target feature, defined relative to the estimated pose of the target-associated keyframe; generating a map of the facility based on the sequence of keyframes; and storing a final target location for the target feature, defined in the facility frame of reference.

Additional examples disclosed herein are directed to a mobile automation apparatus comprising: a locomotive mechanism; a navigational sensor; an environmental sensor; a navigational controller connected to the memory, the locomotive mechanism and the navigational sensor; the navigational controller configured to: obtain mapping trajectory data defining a trajectory traversing a facility to be mapped; control the locomotive mechanism to traverse the trajectory; generate a sequence of keyframes and corresponding estimated mobile automation apparatus poses in a facility frame of reference during traversal of the trajectory, using the navigational sensor; simultaneously with generating a target-associated one of the keyframes, detect a target feature using the environmental sensor; store a relative target location of the target feature, defined relative to the estimated pose of the target-associated keyframe; generate a map of the facility based on the sequence of keyframes; and store a final target location for the target feature, defined in the facility frame of reference.

Further examples disclosed herein are directed to non-transitory computer-readable medium storing computer-readable instructions executable by a navigational controller of a mobile automation apparatus to configure the navigational controller to: obtain mapping trajectory data defining a trajectory traversing a facility to be mapped; control a locomotive mechanism to traverse the trajectory; generate a sequence of keyframes and corresponding estimated mobile automation apparatus poses in a facility frame of reference during traversal of the trajectory, using a navigational sensor; simultaneously with generating a target-associated one of the keyframes, detect a target feature using a environmental sensor; store a relative target location of the target feature, defined relative to the estimated pose of the target-associated keyframe; generate a map of the facility based on the sequence of keyframes; and store a final target location for the target feature, defined in the facility frame of reference.

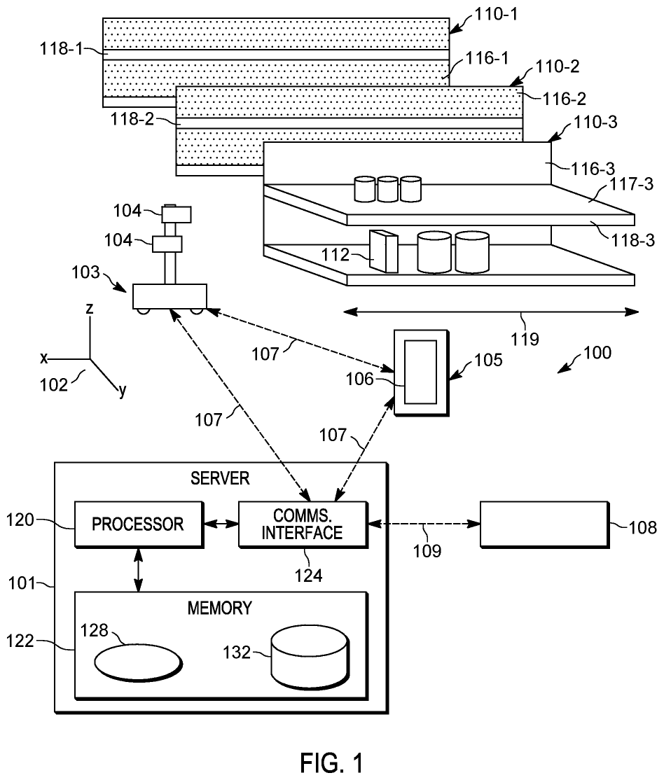

FIG. 1 depicts a mobile automation system 100 in accordance with the teachings of this disclosure. The system 100 is illustrated as being deployed in a retail environment, but in other embodiments can be deployed in a variety of other environments, including warehouses, hospitals or other healthcare facilities, and the like. The environment in which the system 100 is deployed may also be referred to herein generically as a facility.

The system 100 includes a server 101 in communication with at least one mobile automation apparatus 103 (also referred to herein simply as the apparatus 103) and at least one client computing device 105 via communication links 107, illustrated in the present example as including wireless links. In the present example, the links 107 are provided by a wireless local area network (WLAN) deployed within the retail environment by one or more access points (not shown). As also illustrated in FIG. 1, the client device 105 and the apparatus 103 can be connected by a communications link 107. In other examples, the server 101, the client device 105, or both, are located outside the retail environment, and the links 107 therefore include wide-area networks such as the Internet, mobile networks, and the like. The system 100 also includes a dock 108 for the apparatus 103 in the present example. The dock 108 is in communication with the server 101 via a link 109 that in the present example is a wired link. In other examples, however, the link 109 is a wireless link.

The client computing device 105 is illustrated in FIG. 1 as a mobile computing device, such as a tablet, smart phone or the like. In other examples, the client device 105 is implemented as another type of computing device, such as a desktop computer, a laptop computer, another server, a kiosk, a monitor, and the like. The client device 105 includes an output assembly, such as any one or more of a display, a speaker and the like, as well as an input assembly, such as a touch screen integrated with the above-mentioned display, a microphone, and the like. In the illustrated example, the client device 105 includes an integrated display and touch screen, also referred to as an interface assembly 106 or an input/output assembly 106, enabling the client device 105 to present data to an operator of the client device 105, as well as to receive commands from the operator. The system 100 can include a plurality of client devices 105 in communication with the server 101 via respective links 107.

The system 100 is deployed, in the illustrated example, in a retail environment including a plurality of support structures such as shelf modules 110-1, 110-2, 110-3 and so on (collectively referred to as shelves 110, and generically referred to as a shelf 110—this nomenclature is also employed for other elements discussed herein). Each shelf module 110 supports a plurality of products 112. Each shelf module 110 includes a shelf back 116-1, 116-2, 116-3 and a support surface (e.g. support surface 117-3 as illustrated in FIG. 1) extending from the shelf back 116 to a shelf edge 118-1, 118-2, 118-3.

The shelf modules 110 are typically arranged in a plurality of aisles, each of which includes a plurality of modules 110 aligned end-to-end. In such arrangements, the shelf edges 118 face into the aisles, through which customers in the retail environment as well as the apparatus 103 may travel. As will be apparent from FIG. 1, the term “shelf edge” 118 as employed herein, which may also be referred to as the edge of a support surface (e.g., the support surfaces 117) refers to a surface bounded by adjacent surfaces having different angles of inclination. In the example illustrated in FIG. 1, the shelf edge 118-3 is at an angle of about ninety degrees relative to each of the support surface 117-3 and the underside (not shown) of the support surface 117-3. In other examples, the angles between the shelf edge 118-3 and the adjacent surfaces, such as the support surface 117-3, is more or less than ninety degrees.

The apparatus 103 is deployed within the retail environment, and communicates with the server 101 (e.g. via the link 107) to navigate, autonomously or partially autonomously, along a length 119 of at least a portion of the shelves 110. The apparatus 103 is equipped with a plurality of navigation and data capture sensors 104, such as image sensors (e.g. one or more digital cameras) and depth sensors (e.g. one or more Light Detection and Ranging (LIDAR) sensors, one or more depth cameras employing structured light patterns, such as infrared light, or the like). The apparatus 103 can be configured to employ the sensors 104 to both navigate among the shelves 110 and to capture data (e.g. images, depth scans and the like) representing the shelves 110 and other features of the facility during such navigation, for further processing by one or both of the apparatus 103 itself and the server 101.

The apparatus 103, autonomously or in conjunction with the server 101, is configured to continuously determine its location within the environment, for example with respect to a map of the environment. The map may, for example, define the positions of obstacles such as the shelves 110 according to a facility frame of reference 102. As will be discussed in greater detail below, the initial generation of the map (e.g. upon deployment of the system 100 in the facility) may be performed by capturing data via the apparatus 103 (e.g. using the sensors mentioned above) in a simultaneous mapping and localization (SLAM) process. Generation of the map can also include marking target feature locations within the map (i.e. according to the frame of reference 102). Target features are static physical features in the facility that can be recognized subsequently by the apparatus 103 for navigation and data capture operations. For example, instructions may be provided to the apparatus 103 to travel to the previously defined location of a target feature and begin a data capture operation. As will be discussed in greater detail below, the apparatus 103 is configured to determine the locations of target features within the map during the mapping process, rather than the target locations being labelled (e.g. manually by a human operator) after map generation is complete.

The server 101 includes a special purpose controller, such as a processor 120, specifically designed to control and/or assist the mobile automation apparatus 103 to navigate the environment and to capture data. The processor 120 can be further configured to obtain the captured data via a communications interface 124 for storage in a repository 132 and subsequent processing (e.g. to generate a map from the captured data, to detect objects such as shelved products 112 in the captured data, and the like). The server 101 may also be configured to transmit status notifications (e.g. notifications indicating that products are out-of-stock, low stock or misplaced) to the client device 105 responsive to the determination of product status data. The client device 105 includes one or more controllers (e.g. central processing units (CPUs) and/or field-programmable gate arrays (FPGAs) and the like) configured to process (e.g. to display via the assembly 106) notifications received from the server 101.

The processor 120 is interconnected with a non-transitory computer readable storage medium, such as the above-mentioned memory 122, having stored thereon computer readable instructions for performing various functionality, including control of the apparatus 103 to capture data within the facility, post-processing of the data captured by the apparatus 103, and generating and providing certain navigational data to the apparatus 103, such as target locations within the facility at which to capture data. The memory 122 includes a combination of volatile (e.g. Random Access Memory or RAM) and non-volatile memory (e.g. read only memory or ROM, Electrically Erasable Programmable Read Only Memory or EEPROM, flash memory). The processor 120 and the memory 122 each comprise one or more integrated circuits. In some embodiments, the processor 120 is implemented as one or more central processing units (CPUs) and/or graphics processing units (GPUs).

The server 101 also includes the above-mentioned communications interface 124 interconnected with the processor 120. The communications interface 124 includes suitable hardware (e.g. transmitters, receivers, network interface controllers and the like) allowing the server 101 to communicate with other computing devices—particularly the apparatus 103, the client device 105 and the dock 108—via the links 107 and 109. The links 107 and 109 may be direct links, or links that traverse one or more networks, including both local and wide-area networks. The specific components of the communications interface 124 are selected based on the type of network or other links that the server 101 is required to communicate over. In the present example, as noted earlier, a wireless local-area network is implemented within the retail environment via the deployment of one or more wireless access points. The links 107 therefore include either or both wireless links between the apparatus 103 and the mobile device 105 and the above-mentioned access points, and a wired link (e.g. an Ethernet-based link) between the server 101 and the access point.

The memory 122 stores a plurality of applications, each including a plurality of computer readable instructions executable by the processor 120. The execution of the above-mentioned instructions by the processor 120 configures the server 101 to perform various actions discussed herein. The applications stored in the memory 122 include a control application 128, which may also be implemented as a suite of logically distinct applications. In general, via execution of the application 128 or subcomponents thereof and in conjunction with the other components of the server 101, the processor 120 is configured to implement various functionality related to controlling the apparatus 103 to navigate among the shelves 110 and capture data. The processor 120, as configured via the execution of the control application 128, is also referred to herein as the controller 120. As will now be apparent, some or all of the functionality implemented by the controller 120 described below may also be performed by preconfigured special purpose hardware controllers (e.g. one or more FPGAs and/or Application-Specific Integrated Circuits (ASICs) configured for navigational computations) rather than by execution of the control application 128 by the processor 120.

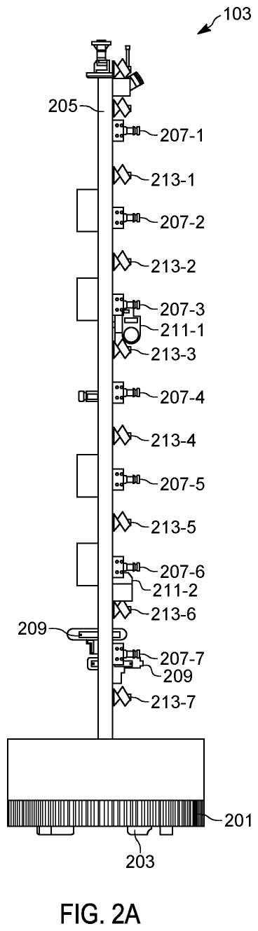

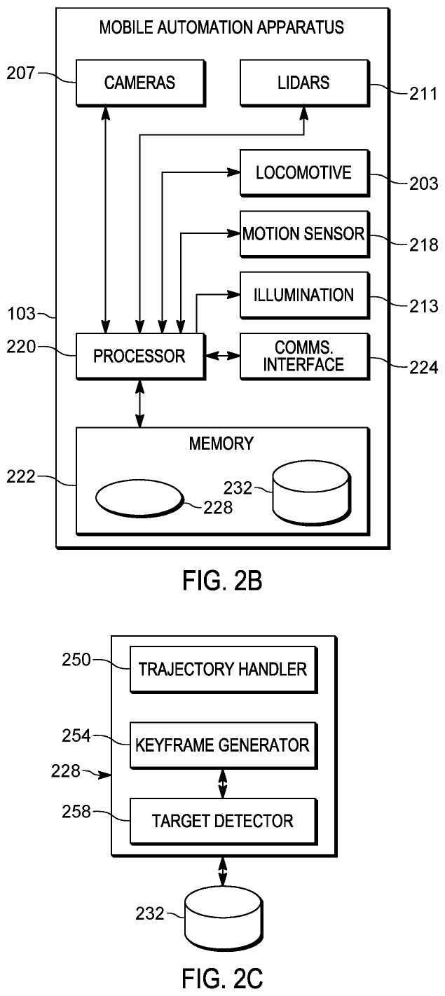

Turning now to FIGS. 2A and 2B, the mobile automation apparatus 103 is shown in greater detail. The apparatus 103 includes a chassis 201 containing a locomotive mechanism 203 (e.g. one or more electrical motors driving wheels, tracks or the like). The apparatus 103 further includes a sensor mast 205 supported on the chassis 201 and, in the present example, extending upwards (e.g., substantially vertically) from the chassis 201. The mast 205 supports the sensors 104 mentioned earlier. In particular, the sensors 104 include at least one imaging sensor 207, such as a digital camera, as well as at least one depth sensor 209, such as a 3D digital camera. The apparatus 103 also includes additional depth sensors, such as LIDAR sensors 211. In other examples, the apparatus 103 includes additional sensors, such as one or more RFID readers, temperature sensors, and the like.

In the present example, the mast 205 supports seven digital cameras 207-1 through 207-7, and two LIDAR sensors 211-1 and 211-2. The mast 205 also supports a plurality of illumination assemblies 213, configured to illuminate the fields of view of the respective cameras 207. That is, the illumination assembly 213-1 illuminates the field of view of the camera 207-1, and so on. The sensors 207 and 211 are oriented on the mast 205 such that the fields of view of each sensor face a shelf 110 along the length 119 of which the apparatus 103 is travelling. The apparatus 103 also includes a motion sensor 218, shown in FIG. 2B. The motion sensor 218 is configured to collect motion data defining movement of the apparatus 103, and can therefore include an inertial measurement unit (IMU) including a combination of accelerometer(s) and gyroscope(s). The motion sensor 218 can also include, in some embodiments, a wheel speed sensor integrated with the locomotive mechanism 203.

The mobile automation apparatus 103 includes a special-purpose navigational controller, such as a processor 220, as shown in FIG. 2B, interconnected with a non-transitory computer readable storage medium, such as a memory 222. The memory 222 includes a combination of volatile (e.g. Random Access Memory or RAM) and non-volatile memory (e.g. read only memory or ROM, Electrically Erasable Programmable Read Only Memory or EEPROM, flash memory). The processor 220 and the memory 222 each comprise one or more integrated circuits. The memory 222 stores computer readable instructions for execution by the processor 220. In particular, the memory 222 stores a navigation application 228 which, when executed by the processor 220, configures the processor 220 to perform various functions related to capturing mapping and localization data, as well as simultaneously capturing target feature locations during the capture of mapping data. The application 228 may also be implemented as a suite of distinct applications in other examples.

The processor 220, when so configured by the execution of the application 228, may also be referred to as a navigational controller 220. Those skilled in the art will appreciate that the functionality implemented by the processor 220 via the execution of the application 228 may also be implemented by one or more specially designed hardware and firmware components, such as FPGAs, ASICs and the like in other embodiments.

The memory 222 may also store a repository 232 containing, for example, data captured during traversal of the above-mentioned mapping trajectory, for use in localization and map generation. The apparatus 103 may communicate with the server 101, for example to receive instructions to navigate to specified target locations and initiate data capture operations, via a communications interface 224 over the link 107 shown in FIG. 1. As will also be discussed below, the apparatus 103 may communicate with the client device 105 during the mapping capture process, to receive operational commands for traversing the mapping trajectory. The communications interface 224 further enables the apparatus 103 to communicate with the server 101 via the dock 108 and the link 109.

As will be apparent in the discussion below, in other examples, some or all of the processing performed by the apparatus 103 may be performed by the server 101, and some or all of the processing performed by the server 101 may be performed by the apparatus 103. That is, although in the illustrated example the application 228 resides in the mobile automation apparatus 103, in other embodiments the actions performed by some or all of the components of the apparatus 103 may be performed by the processor 120 of the server 101, either in conjunction with or independently from the processor 220 of the mobile automation apparatus 103. As those of skill in the art will realize, distribution of navigational computations between the server 101 and the mobile automation apparatus 103 may depend upon respective processing speeds of the processors 120 and 220, the quality and bandwidth of the link 107, as well as criticality level of the underlying instruction(s).

Turning now to FIG. 2C, before describing the actions taken by the apparatus 103 to perform mapping and target localization operations, certain components of the application 228 will be described in greater detail. As will be apparent to those skilled in the art, in other examples the components of the application 228 may be separated into distinct applications, or combined into other sets of components. Some or all of the components illustrated in FIG. 2C may also be implemented as dedicated hardware components, such as one or more ASICs or FPGAs.

The application 228 includes a mapping trajectory handler 250 configured to maintain a mapping trajectory to be followed by the apparatus 103 during traversal of the facility to capture data for map generation and target localization. The application 228 further includes a keyframe generator 254 configured to control the locomotive mechanism 203 to travel through the facility autonomously, in response to operational commands received from an operator (e.g. via the client device 105), or a combination thereof. The keyframe generator 254 is also configured to periodically capture data representing both motion of the apparatus 103 since a preceding keyframe capture, and the environment of the apparatus 103, using the sensors noted above. Each set of captured data is referred to as a keyframe, and the keyframe generator 254 is also configured to generate a current estimated pose of the apparatus 103 (e.g. according to the facility frame of reference 102) for each keyframe.

The application 228 further includes a target feature detector 258 configured, simultaneously with the capture of at least a subset of the keyframes mentioned above, to detect one or more target features in captured data. The captured data employed by the target detector 258 may be the same data as captured for the corresponding keyframe. In other examples the captured data employed by the target detector 258 is captured using additional sensors not employed in keyframe generation. The target detector is also configured to determine a relative location of the detected feature(s), defined relative to the estimated pose for the corresponding keyframe. As will be discussed herein, the relative location of a target feature is employed subsequently to place a target location on the map according to the facility frame of reference 102.

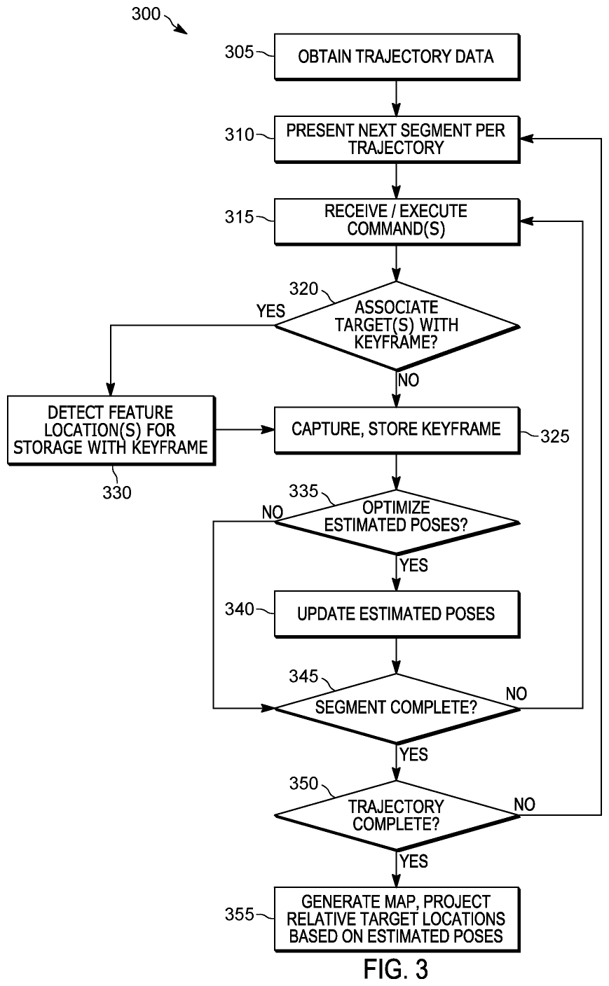

The functionality of the application 228 will now be described in greater detail. In particular, the collection of data for map generation and target feature localization as mentioned above will be described as performed by the apparatus 103. Turning to FIG. 3, a method 300 of dynamic target feature mapping is shown. The method 300 will be described in conjunction with its performance by the apparatus 103, with reference to the components illustrated in FIGS. 2B and 2C.

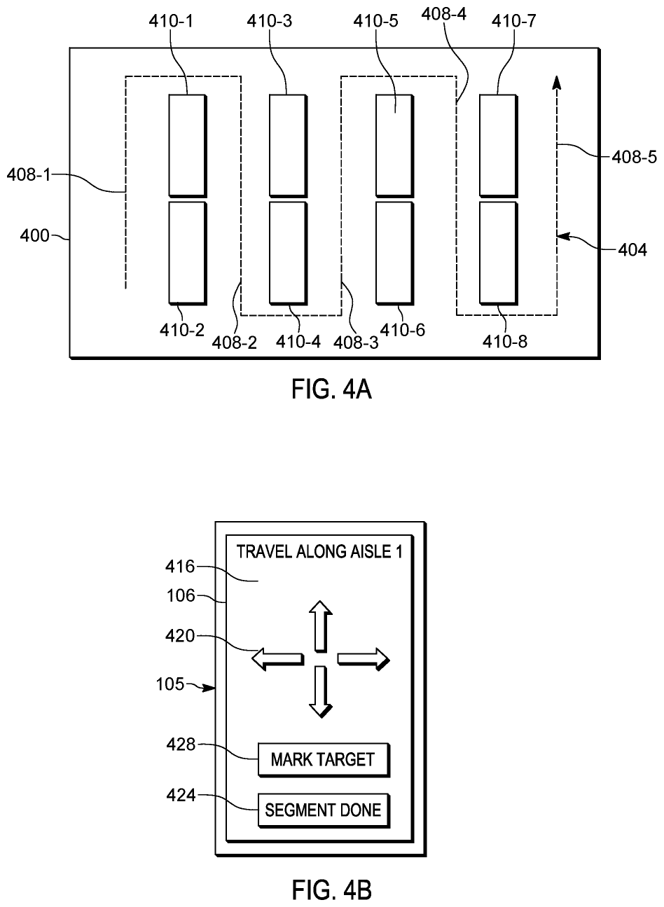

At block 305, the apparatus 103, and particularly the trajectory handler 250, is configured to obtain mapping trajectory data. The mapping trajectory data defines a plurality of trajectory segments each corresponding to a region of the facility to be mapped. The mapping trajectory data can be obtained, for example, by retrieval from the server 101, where the mapping trajectory data can be stored in the repository 132. The specific nature of the segments defined by the mapping trajectory data may vary according to the layout of the facility. In the present example, in which the facility is a retail facility containing a plurality of shelf modules 110 arranged into aisles, the segments each correspond to an aisle defined by a set of one or more shelf modules 110. Turning to FIG. 4A, an overhead view of a facility 400 is shown, including a plurality of shelf modules 410-1, 410-2, 410-3, 410-4, 410-5, 410-6, 410-7 and 410-8. The shelf modules 410 are arranged in end-to-end pairs, with the pairs of modules 410 defining aisles (i.e. spaces between the modules 410), through which the apparatus 103, as well as customers and the like, can travel.

Also illustrated in FIG. 4A is a mapping trajectory 404 including a plurality of segments 408-1, 408-2, 408-3, 408-4 and 408-5. As will be apparent, the segments 408 each correspond to one of the above-mentioned aisles. In other examples, however, the segments need not correspond to the aisles, and can instead correspond to smaller or larger regions of the facility 400 than those represented by the aisles.

The mapping trajectory data can also define one or more instructions associated with each segment 408, to be presented to an operator of the apparatus 103 via display (e.g. the assembly 106 of the client device 105). That is, during the traversal of the trajectory 404, the apparatus 103 is assisted by an operator rather than operating entirely autonomously. Therefore, the apparatus 103 is configured, based on the mapping trajectory data, to provide instructions informing the operator of where in the facility to pilot the apparatus 103. Example mapping trajectory data is shown below in Table 1, including the above-mentioned instructions.

TABLE 1
Example mapping trajectory data

| Segment ID | Operator Instructions | Status |
|---|---|---|
| 408-1 | Travel along Aisle 1 | Pending |
| 408-2 | Travel along Aisle 2 | Pending |
| 408-3 | Travel along Aisle 3 | Pending |
| 408-4 | Travel along Aisle 4 | Pending |
| 408-5 | Travel along Aisle 5 | Pending |

As seen above, in addition to a segment identifier and associated operator instructions, the mapping trajectory data includes a status indicator for each segment. The status indicator can include, for example an indication of whether traversal of the segment is complete or not. In the present example, each segment 408 is shown as “pending”, indicating that none of the segments 408 have been completed. A wide variety of other status indicators may also be employed, including binary flags (e.g. the value “1” for a completed segment, and the value “0” for an incomplete segment) and the like.

Returning to FIG. 3, at block 310 the apparatus 103 (specifically, the trajectory handler 250) is configured to select the next incomplete segment 408 and to present the selected segment via an output device. In the present example, the apparatus 103 is configured to transmit the operator instruction for the selected segment 408 to the client device 105, for presentation on the assembly 106. FIG. 4B illustrates a rendered operator instruction 416 on the assembly 106. The assembly 106 also renders, as shown in FIG. 4B, selectable navigational elements 420 by which the client device 105 is configured to receive operational commands from the operator and transmit the operational commands to the apparatus 103 for execution via control of the locomotive mechanism 203 by the processor 220. The operational commands mentioned above are employed to pilot the apparatus 103 according to the instruction 416. FIG. 4B also illustrates a selectable element 424 for indicating that a segment 408 of the trajectory 404 is complete. FIG. 4B further illustrates a selectable element 428 for indicating that one or more target features are to be detected for a current keyframe, as will be discussed below in connection with the method shown in FIG. 3.

Referring again to FIG. 3, at block 315 the apparatus 103 is configured to receive and execute the above-mentioned operational commands to travel along the mapping trajectory. As will be discussed below, during travel along the trajectory 404, the apparatus 103 is configured to generate a plurality of keyframes each containing data depicting the surroundings of the apparatus 103, as well as an estimated pose of the apparatus 103 relative to the facility frame of reference 102. The keyframes are employed subsequently to generate a map of the facility (e.g. for storage in one or both of the repositories 132 and 232, and for use in autonomous navigation of the facility by the apparatus 103). As will also be discussed below, the apparatus 103 is also configured, simultaneously with the generation of at least some of the captured keyframes, to detect target features within the facility and store relative locations of those target features, for later use in placing final target locations (according to the facility frame of reference 102) in the map.

The apparatus 103 is configured to generate a new keyframe periodically during the execution of the operational commands at block 315. For example, the apparatus 103 can be configured to generate a new keyframe in a sequence of keyframes at predefined travel distances (e.g. a new keyframe can be generated after each displacement of two meters). As a further example, the apparatus 103 can be configured to generate a new keyframe each time a predefined time period elapses. In further examples, the apparatus 103 can generate a new keyframe responsive to selection of the element 428 shown in FIG. 4B. In other words, while executing the operational commands to travel along the trajectory 404, the apparatus 103 may perform numerous instances of the blocks of the method 300 related to keyframe generation.

When a keyframe is to be generated, at block 320 the apparatus 103, and particularly the target detector 258, is configured to determine whether to associate target features with the keyframe. The determination at block 320 can be made, for example, based on whether an instruction has been received from the client device 105 to detect target features. For example, the operator of the client device 105 and the apparatus 103 may select the element 428 responsive to controlling the apparatus 103 to arrive alongside a predetermined target feature in the facility. Various examples of target features are contemplated, including boundaries of the modules 410. The module boundaries are the substantially vertical edges of the modules 410 (i.e. the left and right edges or sides of the modules 410, as viewed when facing the modules 410 in an aisle).

When the determination at block 320 is negative (e.g. when the element 428 has not been selected) the performance of the method 300 proceeds to block 325. At block 325, the keyframe generator 254 is configured to generate a keyframe by capturing sensor data, determining an estimated pose of the apparatus 103, and storing the estimated pose as well as the sensor data in the memory 222.

In the present example, each keyframe is generated at block 325 using data captured by one or more navigational sensors of the apparatus 103. The navigational sensors, in the present example, including the motion sensor 218 (e.g. an IMU) and an environmental sensor such as one or more of the cameras 207 and/or one or more of the lidars 211. The keyframe captured at block 325 includes sensor data (e.g. image data and/or lidar scan data, in the present example) representing the surroundings of the apparatus 103 from the current pose of the apparatus within the facility 400. The keyframe also includes an estimated pose generated at block 325, indicating both the location of the apparatus 103 and the orientation of the apparatus 103 with respect to the facility frame of reference 102.

The estimated pose is generated at block 325 based on a preceding pose corresponding to the preceding keyframe, as well as on one or both of the motion data from the motion sensor 218 and the environmental data from the environmental sensor. For example, odometry data from the motion sensor 218 indicates changes in orientation, as well as distance travelled by the apparatus 103, since the preceding keyframe. Further, environmental sensor data such as a lidar scan may indicate, based on a degree to which the current scan data matches the preceding scan data, a change in pose between the preceding pose and the current pose.

In other words, the apparatus 103 is configured to determine an estimated pose for each keyframe relative to the previous keyframe. The determination of estimated pose at block 325 may be subject to certain errors, however. For example, the motion sensor 218 may be subject to a degree of measurement error, drift or the like. Further, the matching of environmental sensor data such as a lidar scan to a preceding lidar scan maybe subject to an imperfect confidence level, indicating that the features matched between the two scans may not actually correspond to the same physical features in the facility 400. As a result, as will be discussed further below, the estimated poses corresponding to the sequence of keyframes generated through multiple performances of block 325 may accumulate errors relative to the true position of the apparatus 103 within the facility 400.

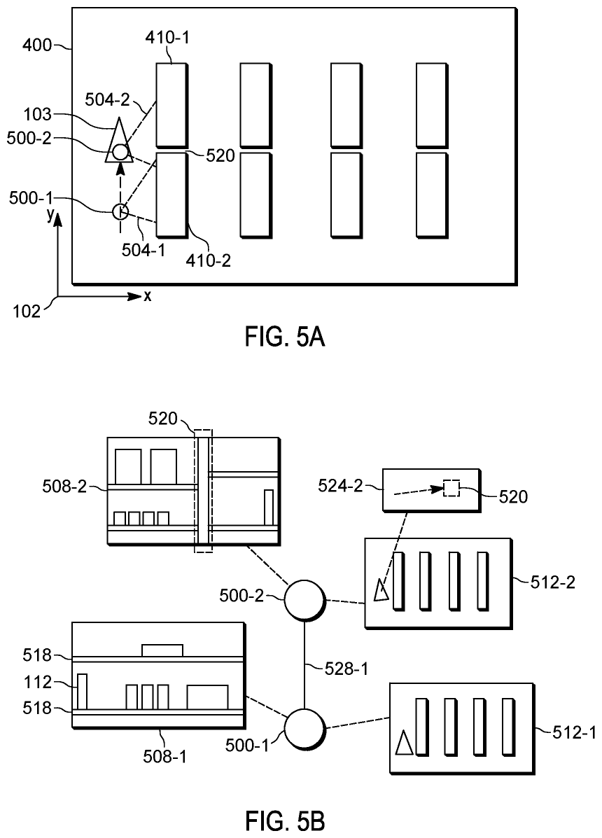

Referring to FIGS. 5A and 5B, a first example performance of block 325 is illustrated, following a negative determination at block 320. In particular, a keyframe 500-1 is shown as having been generated at the location shown in FIG. 5A, during travel of the apparatus 103 along a first segment of the trajectory 404. FIG. 5B graphically illustrates the contents of the keyframe 500-1, although it will be understood that the keyframes generated via performance of block 325 need not be stored graphically. Indeed, any of a wide variety of suitable formats may be employed to store the data contained in each keyframe 500. The keyframe 500-1, as illustrated in FIG. 5B, contains an environmental scan 508-1 (e.g. a lidar scan, as noted above), corresponding to a sensor field of view 504-1 (FIG. 5A). Thus, the environmental scan 508-1 contains data representing a portion of the shelf module 410-2, in which products 112 and shelf edges 518 are visible. The keyframe 500-1 also contains an estimated pose 512-1 indicating the estimated pose of the apparatus 103 at the time the scan data 508-1 was captured, according to the facility frame of reference 102. The estimated pose is represented graphically in FIG. 5B, but can also be stored as a set of coordinates, such as X and Y coordinates and an orientation angle relative to the origin of the facility frame of reference 102.

Returning briefly to FIG. 3, when the determination at block 320 is affirmative (e.g. when the selectable element 428 shown in FIG. 4B is selected) the apparatus 103 proceeds to block 330. At block 330 the target detector 258 is configured to detect one or more target features in the facility. Blocks 330 and 325, in the present example, are performed substantially simultaneously. That is, the detection of target features and the capture of a keyframe are both performed at the current location of the apparatus 103 within the facility 400. Detection of target features at block 330 can be performed using the environmental sensor data mentioned above in connection with block 325. In some examples, at block 330 the target detector is configured to enable one or more additional environmental sensors, such as the depth camera 209, to generate point cloud data representing the field of view 504.

The features that the target detector 258 is configured to detect can be preconfigured. For example, the target detector 258 can be configured to detect boundaries between modules 410 by examining the captured environmental sensor data to identify adjacent vertical edges indicating the presence of a module boundary. As will be apparent to those skilled in the art, a wide variety of other features may also be preconfigured for detection by the target detector 258. Examples of such features include static visual markers placed in the facility, such as aisle number signs, structural features such as endcaps of modules 410, and the like. The target detector 258 is configured, at block 330, to process the captured environmental data and determine whether any of the preconfigured target features are present in the captured data.

When a target feature is detected at block 330, the target detector 258 is configured to determine the location of the target feature relative to the apparatus 103 (as opposed to the location of the target feature relative to the facility frame of reference 102). The relative location of the target feature is determined based on calibration parameters of the environmental sensors (e.g. focal distance and resolution of the depth camera 209, as well as the position of the depth camera 209 relative to the chassis 201). Having determined the relative location of one or more target features at block 330, at block 325 the apparatus 103 is configured to capture a keyframe as described above.

When the performance of block 325 is accompanied by the performance of block 330, the keyframe captured at block 325 is stored along with the relative location of any target features detected at block 330. Referring again to FIGS. 5A and 5B, a second keyframe generation is also shown, for which the determination at block 320 is affirmative. Specifically, a keyframe 500-2 is shown as having been generated at the current position of the apparatus 103. The keyframe 500-2 includes sensor data captured within the field of view 504-2, which, as seen in FIG. 5A, encompasses a boundary 514 between the modules 410-1 and 410-2. The keyframe 500-2, as shown in FIG. 5B, therefore includes not only an environmental scan 508-2 (e.g. lidar data or the like, as discussed above in connection with the keyframe 500-1), but also an indication of the relative location of the boundary feature 520, relative to the estimated pose 512-2 associated with the keyframe 500-2. A relative location 524-2 is represented graphically in FIG. 5B, indicating a direction and distance from the estimated pose 512-2 of the apparatus 103. In the present example, the keyframes 500 are stored in a graph structure also referred to as a pose graph. Thus, the keyframes 500-1 and 500-2 are stored as nodes in the pose graph, connected by an edge 528-1. As will be apparent, additional keyframes captured through further performances of block 325 (with or without block 330) are stored as further nodes connected in sequence with the nodes shown in FIG. 5B.

Returning to FIG. 3, following the generation of a keyframe (with or without the detection and storage of relative target feature locations), the apparatus 103 is configured to determine, at block 335, whether to optimize the pose graph containing each keyframe. As will be understood by those skilled in the art, pose graph optimization includes the modification of one or more estimated poses from the keyframes 500 collected thus far, to minimize one or more error metrics (e.g. maximize agreement between each estimated pose relative to the adjacent estimated poses). Various mechanisms for performing pose graph optimization will occur to those skilled in the art. Examples of such mechanisms include optimization packages such as the Georgia Tech Smoothing and Mapping (GTSAM) library, the g2o framework for graph optimization, and the Ceres library. The determination at block 335 can be based on a current estimation of the accumulated error in the estimated pose of the apparatus 103. In other examples, optimization may be performed at configurable intervals (e.g. after every tenth keyframe is captured, after each keyframe capture, or the like).

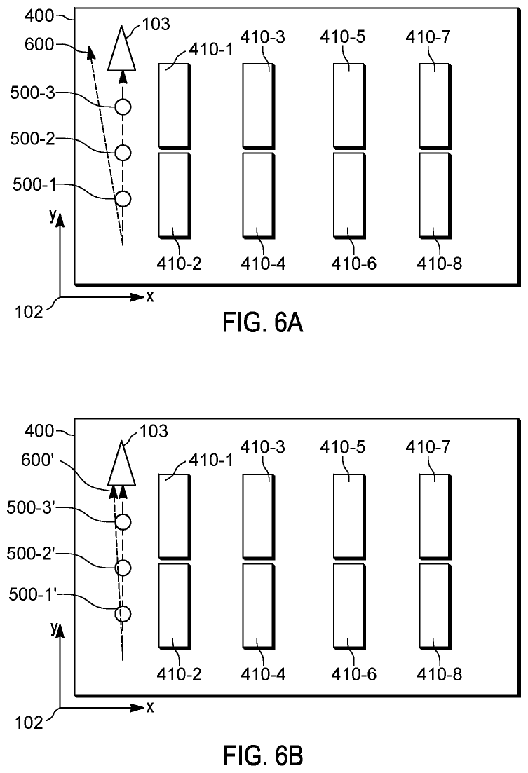

When the determination at block 335 is affirmative, the apparatus 103 is configured to update one or more of the estimated poses stored in conjunction with the keyframes generated through repeated performances of block 325. Referring to FIG. 6A, the facility 400 is illustrated following further travel of the apparatus 103 along the trajectory 404. An additional keyframe 500-3 has been generated through a further performance of block 325. The keyframes 500 each contain an estimated pose, and due to accumulating sensor errors in the estimated poses 512, a perceived trajectory 600 (shown as a dotted line) defined by the estimated poses deviates from the actual trajectory (shown as a dashed line) taken by the apparatus 103. Uncorrected, the perceived trajectory 600 may lead to the generation of a distorted map of the facility 400, and of incorrect target feature labels in the map.

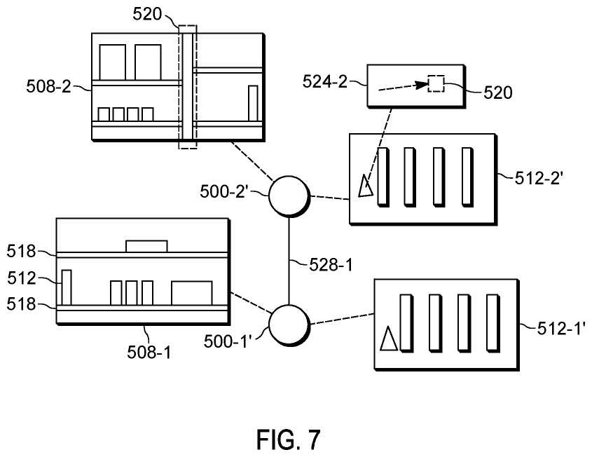

FIG. 6B illustrates updated keyframes 500-1′, 500-2′ and 500-3′ following a pose graph optimization operation. The estimated poses 512 of each keyframe 500′ have been updated, and as a result the perceived trajectory 600′ more closely matches the true trajectory of the apparatus 103 through the facility 400. For example, turning to FIG. 7, updated keyframes 500-1′ and 500-2′ are shown, in which the estimated poses 512-1 and 512-2 have been updated to estimated poses 512-1′ and 512-2′. Of particular note, however, the relative location 524-2 of the target feature 520 has not been updated, although the estimated pose 512-2 upon which the relative location 524-2 is based has been updated.

Returning to FIG. 3, after block 340 (or following a negative determination at block 335) the apparatus 103 is configured to determine whether the current segment (presented at block 310) is complete at block 345. For example, the determination at block 345 can include a determination as to whether the selectable element 424 shown in FIG. 4B has been selected by the operator of the client device 105. When the determination at block 345 is negative, the apparatus 103 returns to block 315 to continue receiving and executing operational commands, as well as generating further keyframes and detecting further relative target locations, for the current segment. When the determination at block 345 is affirmative, the apparatus 103 is configured to determine, at block 350, whether the entire trajectory 404 is complete (e.g. whether indications have been received that each segment 408 listed in the trajectory data is complete). When the determination at block 350 is negative, the next segment is selected from the trajectory data obtained at block 305, and presented at block 310.

When the determination at block 350 is affirmative, the performance of the method 300 proceeds to block 355. At block 355, the apparatus 103 is configured to generate a map of the facility using the keyframes 500 (or updated keyframes 500′, where keyframes 500 have been updated via the performance of block 340). The map can be generated by combining the environmental scans 508 of the captured keyframes 500, positioned relative to each other according to the estimated poses associated with the keyframes 500.

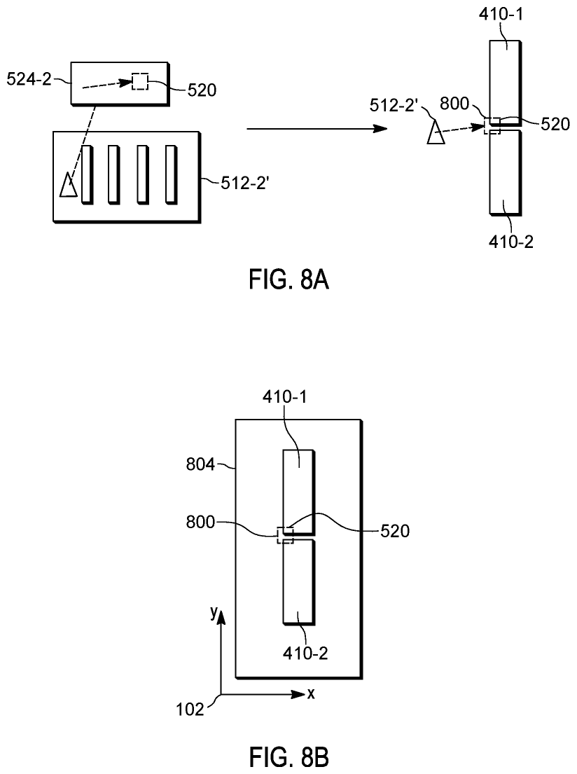

In addition to generating the map at block 355, the apparatus 103 is configured to generate and store a final location for each target feature detected at block 330. The final location for each target feature is defined according to the facility frame of reference 102, rather than relative to the estimated pose 512 of the corresponding keyframe. In particular, the final location is determined by projecting the relative location 524 onto the facility frame of reference 102 based on the final estimated pose 512 of the associated keyframe. FIG. 8A illustrates the generation of a final location 800 for the target feature 520 (i.e. the boundary between the modules 410-1 and 410-2 based on the estimated pose 512-2′ and the relative location 524-2. FIG. 8B illustrates a partial map 804 of the facility, generated from the keyframes 500-1, 500-2 and 500-3 and including the final location 800 of the feature 520. The map 804 can be stored in either or both of the repositories 132 and 232 for subsequent use. For example, the server 101 can be configured to issue instructions to the apparatus 103 to travel to the feature 520, referred to by the final location 800.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for dynamic target feature mapping in a mobile automation apparatus, the method comprising:
at a navigational controller of the mobile automation apparatus, obtaining mapping trajectory data defining a trajectory traversing a facility to be mapped;
at the navigational controller, controlling a locomotive mechanism of the mobile automation apparatus to traverse the trajectory;
at the navigational controller, generating a sequence of keyframes and corresponding estimated mobile automation apparatus poses in a facility frame of reference during traversal of the trajectory, using a navigational sensor of the mobile automation apparatus;
at the navigational controller, simultaneously with generating a target-associated one of the keyframes, detecting a target feature using an environmental sensor of the mobile automation apparatus;
storing a relative target location of the target feature, defined relative to the estimated pose of the target-associated keyframe;
generating a map of the facility based on the sequence of keyframes; and
storing a final target location for the target feature, defined in the facility frame of reference.

2. The method of claim 1, further comprising:
at the navigational controller, prior to generating the map, performing a pose graph optimization to generate an updated estimated pose for the target-associated keyframe; and
determining the final target location based on the updated estimated pose and relative location.

3. The method of claim 1, further comprising:
receiving operational commands via an input assembly connected to the navigational controller; and
controlling the locomotive mechanism according to the operational commands.

4. The method of claim 1, wherein the navigational sensor includes at least one of a motion sensor and the environmental sensor.

5. The method of claim 1, wherein the environmental sensor includes a depth camera.

6. The method of claim 1, wherein detecting the target feature includes detecting preconfigured attributes in data captured using the environmental sensor.

7. The method of claim 1, wherein the target feature includes a feature of a support structure.

8. The method of claim 7, wherein the target feature includes a support structure module boundary.

9. The method of claim 1, further comprising:
prior to detecting the target feature, receiving a command to initiate target feature detection via a communications interface of the mobile automation apparatus.

10. A mobile automation apparatus comprising:
a locomotive mechanism;
a navigational sensor;
an environmental sensor;
a navigational controller connected to the memory, the locomotive mechanism and the navigational sensor; the navigational controller configured to:
obtain mapping trajectory data defining a trajectory traversing a facility to be mapped;
control the locomotive mechanism to traverse the trajectory;
generate a sequence of keyframes and corresponding estimated mobile automation apparatus poses in a facility frame of reference during traversal of the trajectory, using the navigational sensor;
simultaneously with generating a target-associated one of the keyframes, detect a target feature using the environmental sensor;
store a relative target location of the target feature, defined relative to the estimated pose of the target-associated keyframe;
generate a map of the facility based on the sequence of keyframes; and
store a final target location for the target feature, defined in the facility frame of reference.

11. The mobile automation apparatus of claim 10, wherein the navigational controller is further configured to:
prior to generating the map, perform a pose graph optimization to generate an updated estimated pose for the target-associated keyframe; and
determine the final target location based on the updated estimated pose and relative location.

12. The mobile automation apparatus of claim 10, wherein the navigational controller is further configured to:
receive operational commands via an input assembly connected to the navigational controller; and
control the locomotive mechanism according to the operational commands.

13. The mobile automation apparatus of claim 10, wherein the navigational sensor includes at least one of a motion sensor and the environmental sensor.

14. The mobile automation apparatus of claim 10, wherein the environmental sensor includes a depth camera.

15. The mobile automation apparatus of claim 10, wherein the navigational controller is further configured, to detect the target feature, to detect preconfigured attributes in data captured using the environmental sensor.

16. The mobile automation apparatus of claim 10, wherein the target feature includes a feature of a support structure.

17. The mobile automation apparatus of claim 16, wherein the target feature includes a support structure module boundary.

18. The mobile automation apparatus of claim 10, wherein the navigational controller is further configured to:
prior to detecting the target feature, receive a command to initiate target feature detection via a communications interface of the mobile automation apparatus.

19. A non-transitory computer-readable medium storing computer-readable instructions executable by a navigational controller of a mobile automation apparatus to configure the navigational controller to:
obtain mapping trajectory data defining a trajectory traversing a facility to be mapped;
control a locomotive mechanism to traverse the trajectory;
generate a sequence of keyframes and corresponding estimated mobile automation apparatus poses in a facility frame of reference during traversal of the trajectory, using a navigational sensor;
simultaneously with generating a target-associated one of the keyframes, detect a target feature using a environmental sensor;
store a relative target location of the target feature, defined relative to the estimated pose of the target-associated keyframe;
generate a map of the facility based on the sequence of keyframes; and
store a final target location for the target feature, defined in the facility frame of reference.

20. The non-transitory computer-readable medium of claim 19, wherein the instructions further configure the navigational controller to:
prior to generating the map, perform a pose graph optimization to generate an updated estimated pose for the target-associated keyframe; and
determine the final target location based on the updated estimated pose and relative location.
